(19) United States
(12) Patent Application Publication
(10) Pub. No.: US 2013/0161092 A1
(43) Pub. Date: Jun. 27, 2013

(54) WIRE HARNESS

(71) Applicants: Mitsuru KURITA, Yokkaichi-city (JP); Yukihiro SHIRAFUJI, Yokkaichi-city (JP); Takeshi SATO, Yokkaichi-city (JP); Isamu HAMAMOTO, Yokkaichi-city (JP); Takeshi MIZUHIRA, Yokkaichi-city (JP); Hitoshi SUZAKI, Yokkaichi-city (JP)

(72) Inventors: Mitsuru KURITA, Yokkaichi-city (JP); Yukihiro SHIRAFUJI, Yokkaichi-city (JP); Takeshi SATO, Yokkaichi-city (JP); Isamu HAMAMOTO, Yokkaichi-city (JP); Takeshi MIZUHIRA, Yokkaichi-city (JP); Hitoshi SUZAKI, Yokkaichi-city (JP)

(73) Assignee: SUMITOMO WIRING SYSTEMS, LTD., Mie (JP)

(21) Appl. No.: 13/611,721

(22) Filed: Sep. 12, 2012

(30) Foreign Application Priority Data
Dec. 21, 2011 (JP) 2011-279927

(51) Int. Cl. H02G 3/04

(52) U.S. Cl. 174/72 A

(57) ABSTRACT

A wire harness includes a wire harness main body having at least one electric wire and a protection material formed by hot pressing a nonwoven material wrapped more than one time around a circumference of at least a portion in a longitudinal direction of the wire harness main body. A slimmed portion is provided to at least one end of the protection material, the slimmed portion being thinner than a middle portion of the protection material so that a portion where an external surface and an internal surface of the nonwoven material make contact with each other is entirely joined in a circumferential direction on a periphery of the wire harness main body.

### CROSS-REFERENCE TO RELATED APPLICATIONS

The present application claims priority under 35 U.S.C. §119 of Japanese Application No. 2011-279927, filed on Dec. 21, 2011, the disclosure of which is expressly incorporated by reference herein in its entirety.

### BACKGROUND OF THE INVENTION

1. Field of the Invention

The present invention relates to a technology that protects an electric wire provided in a vehicle and the like.

2. Description of Related Art

Prior Art 1 discloses a technology that performs hot pressing to cure nonwoven fabric covering an electric wire.

Prior Art 1: Japanese Patent Laid-Open Publication No. 2011-160611

Depending on a purpose of use, there is a case where nonwoven fabric is hot pressed so as to retain softness to a certain degree. Such nonwoven fabric retaining softness to a certain degree can be obtained by performing hot pressing on nonwoven fabric having lower compression ratio, at a lower temperature, or for a shorter period of time.

In hot pressing nonwoven fabric so as to have softness to a certain degree as described above, however, there is a chance that nonwoven fabric wrapping around an electric wire is not sufficiently joined between each layer of the nonwoven fabric and thus becomes displaced in an axial direction of the electric wire.

In view of the circumstance above, an advantage of the present invention is to prevent displacement of a hot pressed nonwoven material when a large portion of the nonwoven material covering a main body of a wire harness is hot pressed to retain a predetermined softness.

### SUMMARY OF THE INVENTION

In order to address the circumstance above, a wire harness according to one aspect of the present invention includes a wire harness main body having at least one electric wire and a protection material formed by hot pressing a nonwoven material wrapped more than one time around a circumference of at least a portion in a longitudinal direction of the wire harness main body. At least one end of the protection material is provided with a slimmed portion thinner than a middle portion of the protection material so that a portion where an external surface and an internal surface of the nonwoven material make contact with each other is entirely joined in a circumferential direction on a periphery of the wire harness main body.

In the wire harness according to another aspect of the present invention, a tapered portion is provided between the slimmed portion and the middle portion, the tapered portion gradually becoming thinner toward the slimmed portion.

In the wire harness according to another aspect of the present invention, the slimmed portion includes a portion of 10 to 40 mm having the same diameter.

In the wire harness according to another aspect of the present invention, the middle portion of the protection material has rigidity enough to maintain own disposition in a vertical state and a bending capability to bend due to external force.

In the present invention according to the above described one aspect, the middle portion of the protection material is thicker than the slimmed portion. Thus, a large portion of the nonwoven material can be hot pressed to have a predetermined degree of softness. Further, at least one end of the protection material is provided with the slimmed portion that is thinner than the middle portion of the protection material so that the outer surface and the inner surface of the nonwoven material are joined to each other on a periphery of the wire harness main body. Thereby, displacement of the hot pressed nonwoven material can be prevented.

The present invention according to the above described another aspect prevents bending from occurring between the slimmed portion and the middle portion.

The present invention according to the above described another aspect sufficiently prevents the displacement with a portion having the same thickness of 10 to 40 mm.

The present invention according to the above described another aspect provides excellent workability in inserting the wire harness.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a side view illustrating a wire harness according to an embodiment of the present invention;

FIG. 2 is a schematic cross-sectional view taken along a line II-II in FIG. 1;

FIG. 3 is a schematic cross-sectional view taken along a line in FIG. 1;

FIG. 4 illustrates the wire harness in a vertical disposition;

FIG. 5 is an explanatory diagram illustrating a production procedure of the wire harness;

FIG. 6 is an explanatory diagram illustrating another production procedure of the wire harness;

FIG. 7 is an explanatory diagram illustrating a mold used for hot pressing;

FIG. 8 is a schematic plan view illustrating a lower mold;

FIG. 9 is a schematic cross-sectional view illustrating a middle portion during a hot pressing operation;

FIG. 10 is a schematic cross-sectional view illustrating a slimmed portion during a hot pressing operation;

FIG. 11 illustrates exemplary work to insert the wire harness;

FIG. 12 illustrates another exemplary work to insert the wire harness; and

FIG. 13 illustrates an example of wire harness arrangement.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

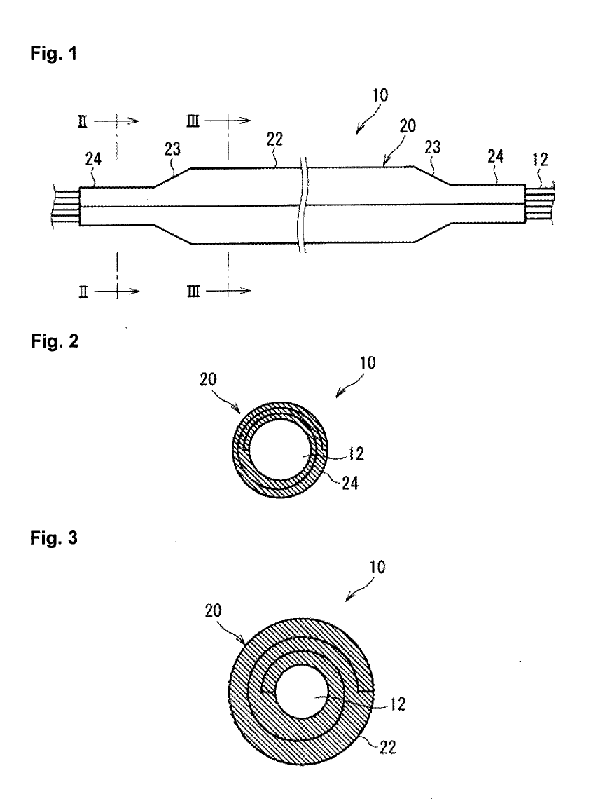

A wire harness according to an embodiment of the present invention is described in the following. FIG. 1 is a side view illustrating a wire harness 10 according to the embodiment. FIG. 2 is a schematic cross-sectional view taken along a line II-II in FIG. 1. FIG. 3 is a schematic cross-sectional view taken along a line in FIG. 1.

The wire harness 10 includes a wire harness main body 12 and a protection material 20.

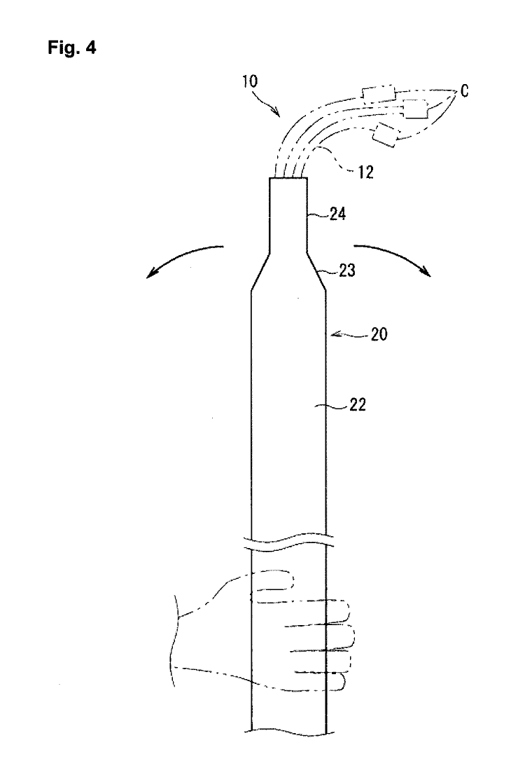

The wire harness main body 12 includes at least one electric wire. In this embodiment, the wire harness main body 12 is configured with a plurality of electric wires bundled along a wiring path in a vehicle where wiring takes place. In general, the plurality of electric wires are bundled so as to have a circular cross-section in a plane perpendicular to a longitudinal direction of the electric wires. The electric wires are wiring materials that electrically and mutually connect various electric components in a vehicle and the like. The wire harness main body 12 may include an optical cable and the like. Furthermore, a connector C that connects to the electric components and the like is installed, as needed, at an end of a portion of the wire harness main body 12 extending out from the protection material 20 (see FIG. 4).

The protection material 20 is formed by hot pressing a nonwoven material (e.g., nonwoven fabric) wrapping more than one time around a circumference of at least a portion in a longitudinal direction of the wire harness main body 12. The protection material 20 may cover substantially an entirety in the longitudinal direction of the wire harness main body 12 or may cover a portion of the wire harness main body 12.

A material capable of curing by undergoing a heating process can be used as a nonwoven material. As such a nonwoven material, a material including elementary fibers and an adhesive resin (may also be referred to as a binder) intertwined with the elementary fibers may be used. The adhesive resin is a resin having a lower melting point (e.g. 110° C. to 115° C.) than the elementary fibers. With the nonwoven material heated to a temperature that is lower than the melting point of the elementary fibers and higher than the melting point of the adhesive resin, the adhesive resin is melted and penetrated into the elementary fibers. Thereafter, once the nonwoven material reaches a temperature lower than the melting point of the adhesive resin, the adhesive resin solidifies while joining the elementary fibers to one another. Accordingly, the nonwoven material increases in hardness compared to a state thereof before heating, and the shape of the nonwoven material is thus maintained in a shape at the time of heating. Further, in a portion of the nonwoven material making contact to another portion thereof, the melted adhesive resin penetrates and solidifies. Thereby, a portion of the nonwoven material is joined to another portion of nonwoven material in a position where the portions are making contact with each other.

The elementary fiber may be any fiber as long as the fiber can remain in a fibrous state at the melting point of the adhesive resin. In addition to a resin fiber, various fibers may be used as the elementary fiber. Further, as the adhesive resin, a thermoplastic resin fiber having a melting point lower than that of the elementary fiber may be used. The adhesive resin may be granular or fibrous. In addition, a binder fiber configured with an adhesive resin layer formed on an outer periphery of a core fiber may be intertwined with the elementary fiber. In this case, a core fiber made of the same material as the elementary fiber may be used.

An example of a combination of the elementary fiber and the adhesive resin includes a resin fiber of PET (polyethylene terephthalate) as the elementary fiber and a copolymer resin of PET and PEI (polyethylene isophthalate) as the adhesive resin. In this case, the melting point of the elementary fiber is approximately 250° C., and the melting point of the adhesive resin is 110° C. to 150° C. Thus, when the nonwoven fabric is heated to a temperature of 110° C. to 250° C., the adhesive resin melts and penetrates into the elementary fibers that remain in a fibrous state without melting. Thereafter, when the temperature of the nonwoven material becomes lower than the melting point of the adhesive resin, the adhesive resin solidifies while connecting the elementary fibers to one another. Thereby, the molded shape is maintained, and the nonwoven materials are joined to each other.

Hot pressing includes heating the nonwoven material and forming a material into a predetermined shape by pressing the material to a mold. Heating and formation into the predetermined shape may be simultaneously performed or may be consecutively performed as separate steps. An example of hot pressing appropriate for producing a protection material 20 according to the present embodiment is described in detail later.

The protection material 20 is hot pressed in a state of covering the wire harness main body 12, and thereby the protection material 20 acts to maintain the wire harness main body 12 in a shape following a predetermined path. In this embodiment, the protection material 20 is formed so as to have a circular cross-section in a direction perpendicular to the longitudinal direction of the protection material. However, the cross-section of the protection material may be oval or polygonal, for example. In this embodiment, an illustration is provided using an example in which the protection material 20 is shaped into a straight line. However, a portion or all of the protection material in the longitudinal direction may be curved.

The protection material 20 covers the wire harness main body 12, and thereby the protection material 20 also acts to prevent (protect) the wire harness main body 12 from interfering (making contact) with an external component. Further, the protection material 20 is flexible and softer than a molded resin article. Thus, the protection material 20 inhibits noise generated by interference between the protection material 20 and an external member. The protection material 20 further allows the wire harness 10 to bend to some extent and be wired along a predetermined wiring path.

The nonwoven material can be processed into either a relatively hard state or a relatively soft state, depending on a condition during hot pressing. For example, the nonwoven material tends to become harder as heating temperature, heating time, and a compression ratio are increased. Accordingly, while enhancing path maintaining capability and a protection capability, the nonwoven material becomes inferior in noise prevention capability and flexibility. On the other hand, as the heating temperature, the heating time, and the compression ratio are decreased, the nonwoven fabric tends to become softer. Accordingly, while enhancing flexibility, the nonwoven fabric becomes inferior in the path maintaining capability and the protection capability. Thus, it is determined which capability is more important based on an arrangement location of the wire harness 10, and it is then determined to what extent hot pressing should be performed on the protection material 20.

The wire harness 10 here is assumed to be inserted and wired in a narrow space such as an interior of a back door that openably and closably covers an opening of a cargo area in a vehicle. It is expected that the wire harness 10 provided in such a narrow space will easily make contact with peripheral components (an inner surface of a panel, a windowpane, and the like) in the narrow space. Thus, the noise control capability is considered to be important. In addition, in consideration of workability in inserting the wire harness 10 from an opening at an end of a back door or the like to install the wire harness 10 in the narrow space, a certain degree of flexibility is considered to be important, the degree of flexibility allowing the wire harness 10 to bend to some extent corresponding to a shape of an insertion space while maintaining a linear shape to some extent. In view of these points, a middle portion 22, which is a portion excluding both ends of the protection material 20 of the wire harness 10, is hot pressed so as to exhibit a predetermined degree of flexibility.

Specifically, the middle portion 22 is hot pressed so as to be hard enough to have rigidity sufficient to maintain a vertical disposition of the wire harness 10 when an end portion of the protection material 20 of the wire harness 10 is held as shown in FIG. 4. At the same time, the middle portion 22 is hot pressed so as to be soft enough to bend without being broken by an external force. Such a condition and a degree of hot pressing can be experimentally and empirically determined by appropriately changing the heating temperature, the heating time, the compression ratio, and the like, as described above.

In order for the nonwoven material to exhibit the predetermined degree of flexibility, the heating temperature, the heating time, or the compression ratio needs to be decreased when hot pressing is performed. In this case, however, overlapping portions of the nonwoven material on a periphery of the wire harness main body 12 may not be sufficiently joined. Thus, it is possible that the nonwoven material wrapped around the wire harness main body 12 becomes displaced along an axis direction on the electric wire.

Accordingly, in this embodiment, slimmed portions 24 are provided at both ends of the protection material 20, the slimmed portions 24 being configured to be thinner than the middle portion 22 of the protection material 20. Although the slimmed portions 24 are provided at both the ends of the protection material 20 in this embodiment, one slimmed portion 24 may be provided at only one end of the protection material 20.

The slimmed portions 24 are each a portion that is hot pressed so as to have a diameter smaller than that of the middle portion 22. That is, the slimmed portions 24 are portions that are hot pressed with a higher compression ratio. Thereby, even when the slimmed portions 24 are hot pressed with the same heating temperature and time as the middle portion 22, the adhesive resin is well melted by hot pressing. Thus, on the periphery of the wire harness main body 12, a portion where an external surface and an internal surface of the nonwoven material make contact with each other is entirely joined in a circumferential direction. Thereby, displacement and separation of the nonwoven material is inhibited at the end of the protection material 20.

In order to prevent the displacement or the separation of the nonwoven material, a length of the slimmed portion 24 is preferably 10 mm or longer. Furthermore, the length of the slimmed portion 24 is preferably 40 mm or shorter since the slimmed portion 24, if being too long, may impair flexibility of the wire harness 10 as a whole. In this embodiment, the length of the slimmed portion 24 is a length of a continuous portion having the same diameter and excluding a tapered portion 23 described below.

The tapered portion 23 is provided between the slimmed portion 24 and the middle portion 22, the tapered portion 23 gradually becoming thinner toward the slimmed portion 24. An end of the tapered portion 23 on a middle portion 22 side has the same diameter as the middle portion 22 and continues to the middle portion 22. Another end of the tapered portion 23 on a slimmed portion 24 side has the same diameter as the slimmed portion 24 and continues to the slimmed portion 24.

An exemplary production of the wire harness 10 is described in the following.

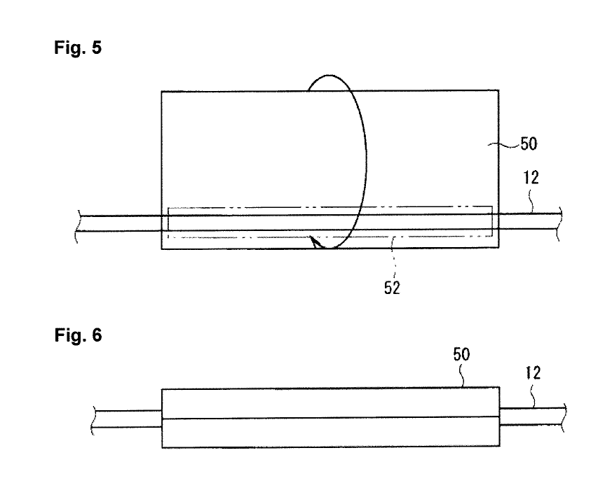

First, a sheet-shaped nonwoven material 50 is prepared, as shown in FIG. 5. The nonwoven material 50 has a rectangular shape whose length is the same as a portion of the wire harness 10, which is to be protected by the protection material 20. A width of the nonwoven material 50 (width in a direction to wrap around the wire harness main body 12) is longer than a circumferential length of the wire harness main body 12 and is preferably long enough to wrap two and half times around the wire harness main body 12. This is because wrapping the protection material 20 two and half times around the wire harness main body 12 provides sufficient path maintaining and protection capabilities. Furthermore, a double-sided tape 52 is adhered to a portion of the nonwoven material 50 facing an inner peripheral side and making contact with the wire harness main body 12 when wrapped around the wire harness main body 12. The wire harness main body 12 is placed along the double-sided tape 52. In a state where one end portion of the nonwoven material 50 and the wire harness main body 12 are fixed to each other with the double-sided tape 52 therebetween, the nonwoven material 50 wraps around the wire harness main body 12.

Thereby, the nonwoven material 50 wrapping around the outer periphery of the wire harness main body 12, as shown in FIG. 6, can be obtained.

Subsequently, hot pressing is performed on the nonwoven material 50 wrapping around the wire harness main body 12. An exemplary configuration of a mold used for hot pressing is described below.

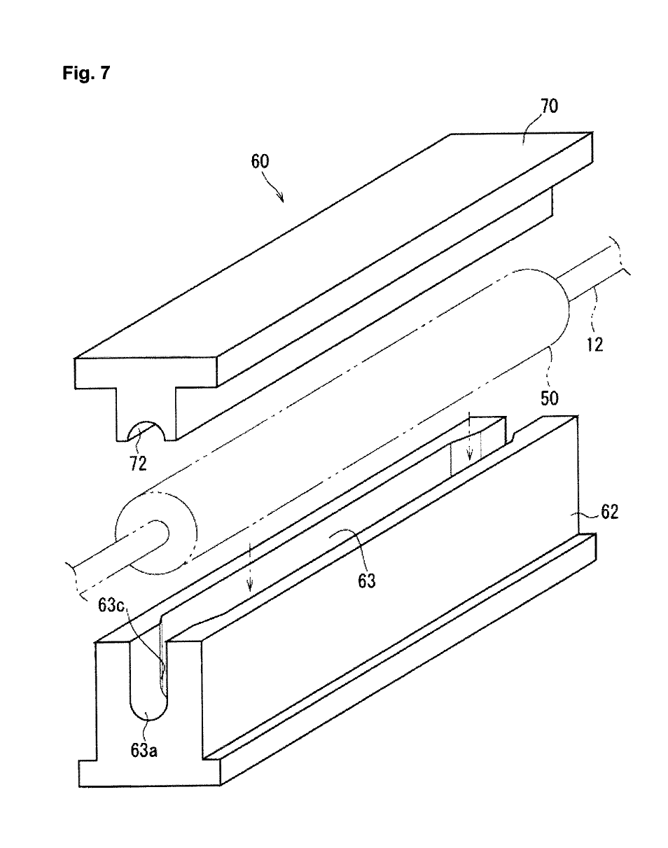

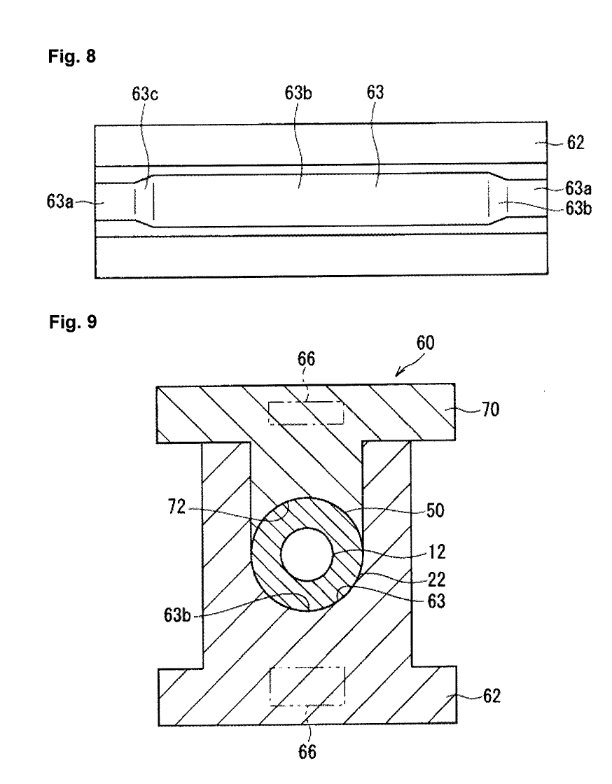

FIG. 7 illustrates a mold 60 for hot pressing operation. FIG. 8 is a plan view illustrating a lower mold 62 of the mold 60 for hot pressing operation. The mold 60 for hot pressing operation is configured with the lower mold 62 and an upper mold 70.

The lower mold 62 is an elongated member formed of metal and the like having excellent thermal conductivity. A lower molding surface 63 is provided on one main surface (upper surface) of the lower mold 62. The lower molding surface 63 has, schematically, a groove shape having openings on an upper side and both ends thereof. A length in a longitudinal direction of the lower molding surface 63 is substantially the same as the length of the portion of the wire harness main body 12 to be protected (portion to be covered by the protection material 20).

A slimmed portion molding surface 63a is provided to each of both bottom ends in the longitudinal direction of the lower molding surface 63. Each slimmed portion molding surface 63a has a semicircular cross-section having an inner diameter corresponding to an outer diameter of the slimmed portion 24 of the protection material 20. In addition, a middle portion molding surface 63b is provided to a bottom of a middle portion in the longitudinal direction of the lower molding surface 63. The middle portion molding surface 63b has a semicircular cross-section having an inner diameter corresponding to an outer diameter of the middle portion 22 of the protection material 20. Moreover, a tapered portion molding surface 63c is provided between the slimmed portion molding surface 63a and the middle portion molding surface 63b of the lower molding surface 63. The tapered portion molding surface 63c has a tapered semicircle shape that gradually becomes thinner toward a slimmed portion molding surface 63a side to correspond to an inclination of the tapered portion 23 of the protection material 20.

The upper mold 70 is an elongated member formed of metal or the like having excellent thermal conductivity. An upper molding surface 72 is provided on one main surface (lower surface) of the upper mold 70 and has a groove shape having an arc-shaped cross-section. The upper molding surface 72 has a width that allows the upper molding surface 72 to be placed in the lower molding surface 63 while closing the upper opening of the lower molding surface 63. The upper molding surface 72 is configured with portions each having the same shape as the slimmed portion molding surface 63a, the middle portion molding surface 63b, and the tapered portion molding surface 63c, respectively, the portions being provided in areas each opposing the slimmed portion molding surface 63a, the middle portion molding surface 63b, and the tapered portion molding surface 63c in the bottom of the lower molding surface 63.

The upper molding surface 72 is placed inside the lower molding surface 63 to form a space that enables formation of the protection material 20 between the upper molding surface 72 and the lower molding surface 63. Furthermore, a heating mechanism 66 such as a heater is provided to each of the lower mold 62 and the upper mold 70.

A method of producing the protection material 20 using the mold 60 for hot pressing operation is described.

Specifically, the nonwoven material 50 covering the wire harness main body 12 as described above is placed inside the lower molding surface 63 of the lower mold 62.

Thereafter, the upper molding surface 72 of the upper mold 70 is inserted in the lower molding surface 63. The nonwoven material 50 is hot pressed in this state inside the mold 60 for hot pressing operation. Specifically, the nonwoven material 50 is heated while being compressed between the lower molding surface 63 and the upper molding surface 72.

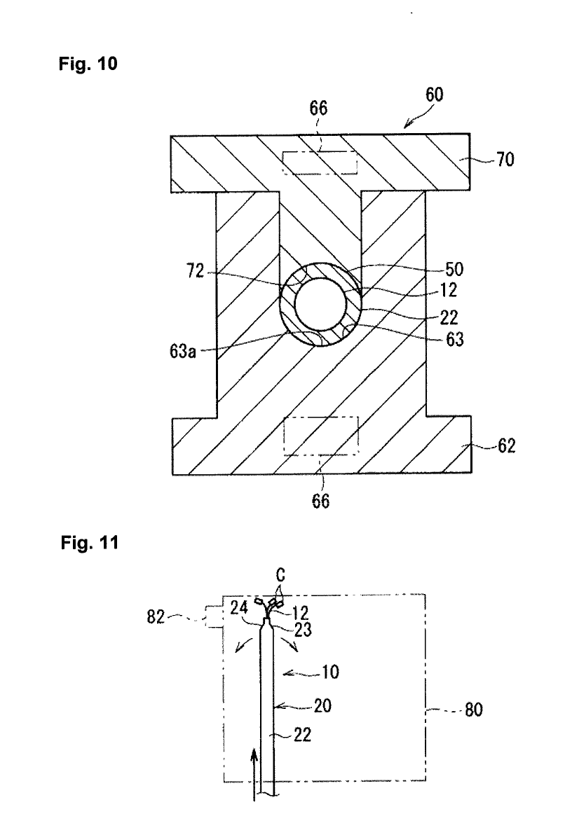

Thereafter, with the nonwoven material 50 being cooled, a surface of the nonwoven material solidifies in a shape corresponding to the lower molding surface 63 and the upper molding surface 72. The wire harness main body 12 here is wrapped for the same number of times by the nonwoven material 50 having the same thickness in the longitudinal direction. Accordingly, the nonwoven material 50 covering the wire harness main body 12 provides wrapping of the same thickness in the longitudinal direction of the wire harness main body 12. In addition, as shown in FIG. 9, a relatively large space is formed in an area of the middle portion molding surface 63b between the lower molding surface 63 and the upper molding surface 72. Thus, the nonwoven material 50 in the middle portion molding surface 63b area is compressed with a relatively small compression ratio between the lower molding surface 63 and the upper molding surface 72. Accordingly, the middle portion 22 of the protection material 20 provided in the middle portion molding surface 63b area is hot pressed so as to be relatively soft. On the other hand, as shown in FIG. 10, a relatively small space is formed in an area of the slimmed portion molding surface 63a. Thus, the nonwoven material 50 in the slimmed portion molding surface 63a area is compressed with a relatively large compression ratio between the lower molding surface 63 and the upper molding surface 72. Thereby, the adhesive resin is well melted in the slimmed portion 24 of the protection material 20 placed in the slimmed portion molding surface 63a area. The slimmed portion 24 is thus hot pressed so as to be relatively hard. Accordingly, in the slimmed portion 24, a portion where the external surface and the internal surface of the nonwoven material 50 make contact with each other is entirely joined in a circumferential direction on the periphery of the wire harness main body 12. Further, the tapered portion 23 is compressed with a compression ratio gradually increasing from the middle portion 22 to the slimmed portion 24. Accordingly, the tapered portion 23 is hot pressed so as to gradually increase hardness from the middle portion 22 to the slimmed portion 24.

An exemplary use of the wire harness 10 is described.

The wire harness 10 is provided, for example, through a gap in a back door 80 that openably and closably covers an opening of a cargo area in a vehicle.

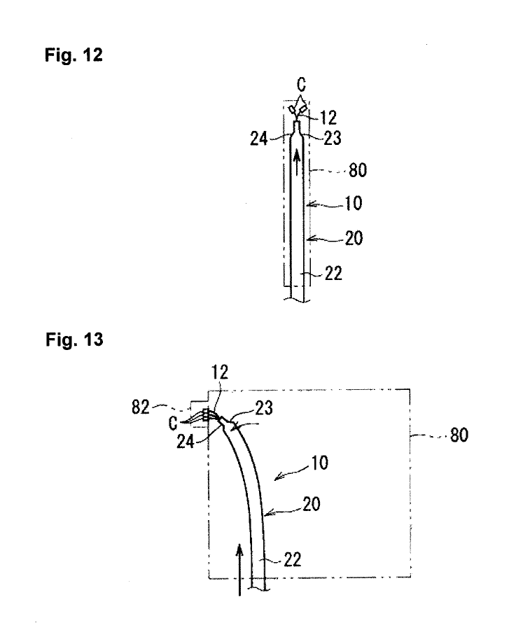

In such a situation, there may be a case where an opening for wire harness insertion is provided at a lower portion of the back door 80 and an electrical equipment 82 to be connected with the wire harness 10 is provided at an upper portion of the back door 80, as shown in FIGS. 11 and 12. In this case, the wire harness 10 is inserted from the lower opening of the back door 80 and is pushed upward through a narrow gap in the back door 80.

The protection material 20 here has a predetermined degree of rigidity enough to maintain own disposition in a vertical state, thereby enabling smooth insertion of the wire harness 10 without bending in the middle of the insertion. Moreover, the protection material 20 has a bending property (flexibility) enough to be bent by an external force. Thus, even when a path in the back door 80 is curved, the wire harness 10 can be inserted following the curve. Furthermore, as shown in FIG. 13, the wire harness 10 is also bendable in a state where a connector at an end of the wire harness 10 is connected to the electric component 82.

According to the wire harness 10 configured as described above, a middle portion of the protection material 20 is thicker than the slimmed portion 24 so that a large portion of the nonwoven material 50 can be hot pressed to have a predetermined degree of softness. Thereby, the middle portion 22 of the protection material 20 is configured to be soft so as to provide noise prevention. In addition, insertion work for wiring the wire harness 10 is facilitated. Furthermore, the slimmed portion 24 is provided to the end of the protection material 20, thereby the protection material 20 successfully joins together in the slimmed portion 24. Thereby, displacement or separation of the protection material 20 can be prevented at the end of the protection material 20. Moreover, the slimmed portion 24 having a smaller diameter is provided to each end of the protection material 20. Thus, insertion work for wiring the wire harness main body 12 is facilitated.

Further, since the tapered portion 23 is provided between the middle portion 22 and the slimmed portion 24, there is a gradual change in rigidity (flexibility) between the middle portion 22 and the slimmed portion 24. Thus, bending is also prevented from occurring between the middle portion 22 and the slimmed portion 24.

Furthermore, since the tapered portion 23 is provided between the middle portion 22 and the slimmed portion 24, a portion between the middle portion 22 and the slimmed portion 24 does not easily get caught by an object during insertion when the wire harness main body 12 is installed by insertion, thereby facilitating the insertion work.

Moreover, the lower molding surface 63 and the upper molding surface 72 need to include only an inclination and do not need to include a step. Thus, the lower molding surface 63 and the upper molding surface 72 can be readily produced by molding.

The present invention was described above in detail. The description above is merely an example in all the aspects, and the present invention is not limited thereto. Various modifications which are not shown here are possible within the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness, comprising
a wire harness main body including at least one electric wire; and
a protection material formed by hot pressing a nonwoven material wrapped more than one time around a circumference of at least a portion in a longitudinal direction of the wire harness main body, wherein
at least one end of the protection material is provided with a slimmed portion thinner than a middle portion of the protection material so that a portion where an external surface and an internal surface of the nonwoven material make contact with each other is entirely joined in a circumferential direction on a periphery of the wire harness main body.

2. The wire harness according to claim 1, wherein a tapered portion is provided between the slimmed portion and the middle portion, the tapered portion gradually becoming thinner toward the slimmed portion.

3. The wire harness according to claim 1, wherein the slimmed portion includes a portion of 10 to 40 mm having the same diameter.

4. The wire harness according to claim 1, wherein the middle portion of the protection material has rigidity enough to maintain own disposition in a vertical state and a bending capability to bend due to an external force.

5. The wire harness according to claim 2, wherein the slimmed portion includes a portion of 10 to 40 mm having the same diameter.

6. The wire harness according to claim 2, wherein the middle portion of the protection material has rigidity enough to maintain own disposition in a vertical state and a bending capability to bend due to an external force.

7. The wire harness according to claim 3, wherein the middle portion of the protection material has rigidity enough to maintain own disposition in a vertical state and a bending capability to bend due to an external force.

8. The wire harness according to claim 5, wherein the middle portion of the protection material has rigidity enough to maintain own disposition in a vertical state and a bending capability to bend due to an external force.
